(19) United States
(12) Patent Application Publication
(10) Pub. No.: US 2025/0290581 A1
(43) Pub. Date: Sep. 18, 2025

(54) CLIP WITH CLAMPING SCREW AND TORQUE LIMITER

(71) Applicant: NORMA GERMANY GMBH, Maintal (DE)

(72) Inventors: Helmut GEPPERT, Maintal (DE); Markus HEEG, Maintal (DE); Björn MÖLLER, Maintal (DE); Natan LANTSMANN, Maintal (DE)

(21) Appl. No.: 18/860,098

(22) PCT Filed: Mar. 14, 2023
(86) PCT No.: PCT/EP2023/056504

§ 371 Date: Oct. 25, 2024

(30) Foreign Application Priority Data
Apr. 25, 2022 (DE) 10 2022 109 926.1

(51) Int. Cl. F16L 33/04

(52) U.S. Cl. CPC F16L 33/04

(57) ABSTRACT

The disclosure relates to a clip having a clip band which has two mutually adjacent ends which can be connected to each other by a clamping apparatus. A clamping screw is provided having a head portion and a shaft portion. The shaft portion has a shaft and a thread region, with which the clamping screw can be screwed to the clamping apparatus. The head portion has a clamping head for applying a pretensioning force in a pretensioning direction. The head portion has an assembly head for tightening the clamping screw and for ensuring a predefined torque. There is provision for the clamping head to have a shear plane at the upper side thereof.

### INTRODUCTION

The disclosure relates to a clip, in particular a hose clip, having a clamping apparatus which has a clamping screw.

Hose clips or clamping clips, such as, for example, worm drive clips, usually comprise an annular metal band and serve to secure a hose end to a fixed connection or to a hose connector. Hose clips are mainly used in the sanitary sector, in automotive manufacturing and in mechanical engineering. They are generally produced in accordance with DIN 3016/3017 and other industrial standards and are made of metal.

For tightening, the clip has a clamping apparatus having an adjusting or clamping screw. This screw is fitted so that, by tightening the clamping screw, the internal diameter of the hose clip is reduced. The hose which is surrounded by the clip is thereby pressed onto the connection piece and seals therewith radially.

During radial sealing, the hose material or the material of the clamping apparatus is powerfully deformed by the clamping force, for which reason excessively powerful tightening of the clamping screw or excessively great pretensioning force can cause damage to the hose and/or the clamping apparatus.

There are already known from the prior art pluggable, adapter-like apparatuses for ensuring a predetermined torque when tightening a clamping screw of a hose clip. The document DE 42 11 132 C2 describes, for example, such a torque safeguarding apparatus for use in hose clips with clamping screws in motor vehicles.

In this instance, one disadvantage is that, in order to ensure a predefined torque, in addition to the clamping screw, an additional apparatus or torque cap has to be used, which is further relatively complex to produce.

### SUMMARY

An object per an embodiment is to overcome this disadvantage and other disadvantages of the prior art and to provide a clip having a clamping apparatus which is produced with simple members and few components in a cost-effective manner and which allows a simplified safeguarding of a predetermined torque.

In a clip having a clip band which has two ends which can be connected to each other by a clamping apparatus which has a clamping screw having a head portion and a shaft portion, wherein the shaft portion has a thread region, with which the clamping screw can be screwed to the clamping apparatus, wherein the head portion has a clamping head for applying a pretensioning force in a pretensioning direction, wherein the head portion has an assembly head for tightening the clamping screw and for ensuring a predefined torque, there is provision according to an embodiment for the clamping head to have a shear plane at the upper side thereof, wherein the shear plane is arranged between the clamping head and the assembly head, wherein the assembly head shears off from the clamping head of the clamping screw if a predefined torque is applied or exceeded at the shear plane.

Generally, as a result of the controlled shearing, an excess stressing of the clip and the clamping apparatus or the clamped components is avoided.

The term “clip” as used herein is intended to be understood in principle to be all types of clips which have at least one clamping apparatus. The disclosure relates particularly to hose and clamping clips mentioned in the introduction, worm drive clips, profile clips, exhaust gas clips and spherical zone exhaust gas clips, pipe clips and retention clips with consoles.

By providing a shear plane which acts virtually as a desired breaking location and which is arranged between the clamping head and assembly head, it is possible to selectively achieve a shearing of the assembly head when a selected torque is reached. In this instance, the assembly head advantageously also serves at the same time to tighten the clamping screw. It is not necessary to use an additional torque securing cap as a result of the integral construction of the assembly and clamping head. When the predefined torque is applied or exceeded, the shear forces at the shear plane between the assembly head and clamping head are so great that the assembly head shears off at the shear plane from the clamping head of the clamping screw. Consequently, it is unnecessary to use a calibrated, electric or pneumatic screwdriver which has to be checked regularly.

When the assembly head shears off, sharp edges at the shear location or breaking location can be produced. Therefore, the breaking location is at risk of corrosion. As a result of the planar shear plane at the upper side of the clamping head, the deburring of sharp edges is advantageously facilitated after the assembly head shears off. According to another variant, the shear plane can be coated in order to achieve corrosion protection (electrolytic protection).

In an embodiment, the disclosure makes provision for the clamping screw to be configured integrally with the clamping head and the assembly head. It is thereby possible to produce all the portions of the clamping screw from screw blanks with little production complexity, for example, by turning, pressing, non-cutting forming, rolling or milling.

In an embodiment, the assembly head has at the lower side thereof a conical attachment, wherein the conical attachment is formed between the shear plane and the assembly head. The conical attachment facilitates the shearing-off action of the assembly head when the predefined torque is exceeded and can, for example, be in the form of an acutely angular annular groove. Preferably, per an embodiment, the conical attachment faces the shear plane with the smaller diameter thereof. When the predetermined torque is applied or exceeded, the assembly head shears off completely at the shear plane. As a result of the conical shape of the attachment and the selective arrangement of the smaller diameter at the shear plane, the shearing-off face is effectively reduced. Furthermore, a clean shearing-off action is thereby supported and sharp edges are reduced.

According to another embodiment, the assembly head has at the upper side thereof a recess for the positive-locking insertion of a tool when the clamping screw is tightened, wherein the recess is, for example, cross-like. In order to tighten the clamping screw, no special tool is then required. As a result of the cross-like recess, conventional screwdrivers can be used. Preferably, per an embodiment, the assembly head has at least two external sides which particularly extend parallel with each other, wherein the assembly head is particularly in the form of a hexagon. It is thereby also possible to use wrenches for applying a torque or for tightening the screw in addition to crosshead and slotted screwdrivers. Alternatively, it is also conceivable to have embodiments which allow the use of an internal Torx, external Torx or internal hexagon socket.

In another embodiment, the disclosure makes provision for the clamping head to have a lower contact side which produces a pressing contact at the clamping apparatus of the clip when the clamping screw is tightened, wherein the pressing contact is produced over a circumferential pretensioning lip at the contact side. Preferably, per an embodiment, the clamping head has a plate-like main body which extends between the circumferential pretensioning lip and the shear plane and which is configured to be greater in diameter than the assembly head, wherein the clamping head has at least two sides. In this case, the clamping head is in the form of a hexagon. As a result of the multi-sided construction, the clamping screw can where necessary also be manually loosened again after the assembly head has sheared off via the clamping head. The plate-like main body of the clamping head is configured to be greater than the assembly head and presses against the component to be secured or against the clamping apparatus when the screw is tightened. The circumferential pretensioning lip improves the force transmission in the pretensioning direction in this case.

In an embodiment, it is preferable for the circumferential pretensioning lip of the clamping head to project further in the pretensioning direction than the main body of the clamping head. As a result of the projecting, lip-like construction of the pretensioning lip, the pretensioning force at the circumferential pretensioning lip is introduced in the form of a line pressure. The contact face is thereby reduced and the lower contact side reacts more stiffly during loading counter to the pretensioning direction. Overall, as a result of the reduced circumferential contact over the pretensioning lip, an increased surface pressure between the clamping head and the clamping apparatus is achieved.

According to another embodiment, the shaft has a conical transition to the main body of the clamping head. There is thereby produced, per this embodiment, a safeguard against undesirable release because the conical or cone-like shaping of the transition increases the friction and transverse forces which act in the screw shaft when the clamping screw is tightened and, when the screw shaft expands, virtually ensures a better metallic seal.

In another embodiment, the disclosure makes provision for the assembly head to be in the form of a hollow profile directly at the shear plane of the clamping head. In an embodiment, the assembly head is also configured with multiple sides in this variant in order to allow subsequent manual release. The recess at the upper side of the assembly head is of cylindrical form. As a result of the direct, thin-walled formation of the assembly head at the shear plane, the entire production complexity of the clamping screw is reduced. Additionally, material costs are thereby saved because the conical attachment is dispensed with and less raw material is required. Overall, the total production costs are reduced by these two factors. In order to reduce the shear face at the shear plane, the assembly head per an embodiment can be configured in a conical manner.

According to another embodiment, the clip is a hose clip for securing a hose end to a fixed connection or to a hose connector. Particularly in line or hose clips which are used in particular in lines in motor vehicles, the use of a clamping screw according to an embodiment in order to ensure a predetermined torque is particularly suitable. When hose clips are clamped, there is an increased risk of damaging the hose material as a result of an excessively great tightening torque. This can in turn result in the connection becoming non-fluid-tight. Furthermore, as a result of the clamping screw according to an embodiment, the tightening of the hose clip without using additional components is substantially simplified.

### BRIEF DESCRIPTION OF THE FIGURES

Other features, details and advantages of the disclosure will be appreciated from the wording of the claims and the following description of exemplary embodiments with reference to the drawings. In the drawings:

FIG. 1a shows a schematic view of a clamping screw according to an embodiment;

FIG. 1b shows a schematic side view of a clamping screw according to an embodiment;

FIG. 1c shows a schematic view of a clamping screw according to an embodiment without an assembly head;

FIG. 1d shows a detailed illustration of the head portion and shaft portion of the clamping screw;

FIG. 2a shows a sectioned illustration of an alternative embodiment of the clamping screw;

FIG. 2b shows a detailed view of a head region of the clamping screw from FIG. 2a;

FIG. 2c shows a schematic view of the clamping screw from FIG. 2a;

FIG. 3a shows a clamping screw according to an embodiment with a worm drive clip;

FIG. 3b shows a clamping screw according to an embodiment with a profile clip;

FIG. 3c shows a clamping screw according to an embodiment with an exhaust gas clip;

FIG. 3d shows a clamping screw according to an embodiment with a pipe clip.

### DETAILED DESCRIPTION

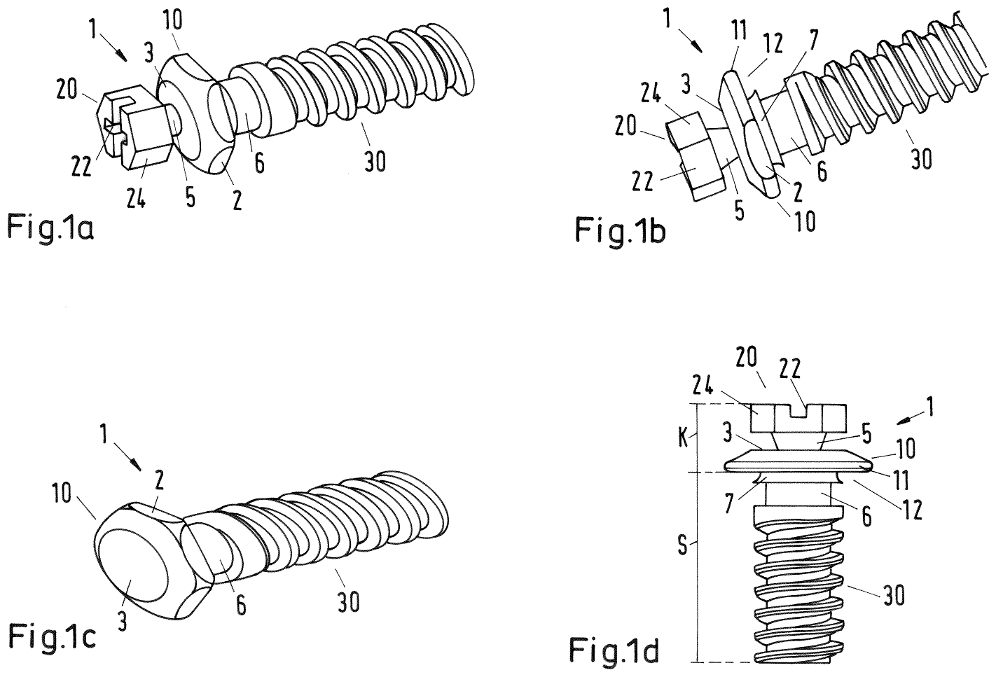

The clamping screw generally designated 1 in FIG. 1a to FIG. 1d is suitable for being screwed to the clamping apparatus in a clip having a clip band which has two mutually adjacent ends which can be connected to each other by a clamping apparatus in order thus to reduce the internal diameter of the clip and to tighten the clip (not illustrated).

As can be seen in particular in FIG. 1d, the clamping screw 1 has a head portion K and a shaft portion S. In this case, an assembly head 20 for tightening the clamping screw 1 and for ensuring a predefined torque M is provided in the region of the head portion K. Furthermore, the head portion K has a clamping head 10 for applying a pretensioning force when the clamping screw 1 is tightened.

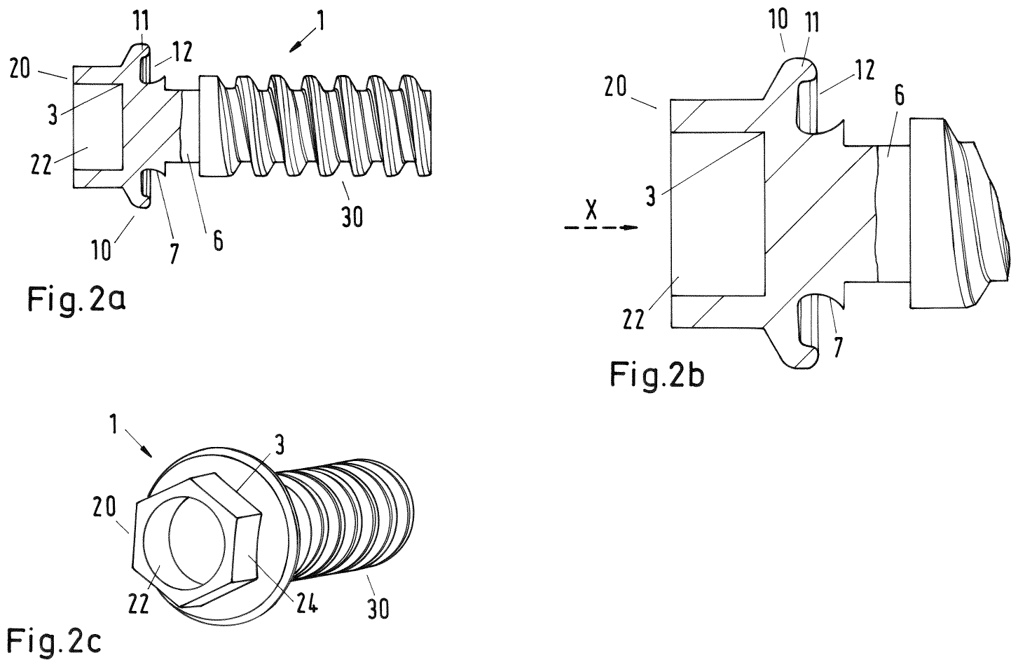

Furthermore, the shaft portion S has a screw shaft 6 and a thread region 30 which is adjacent thereto and with which the clamping screw 1 can be screwed to the clamping apparatus (not shown). Furthermore, the clamping screws 1 which are shown in the embodiments according to FIG. 1 and FIG. 2 are configured integrally.

The clamping head 10 is provided at the upper side thereof with a shear plane 3 which is arranged between the clamping head 10 and the assembly head 20. The assembly head 20 is configured in such a manner that it shears off from the clamping head 10 of the clamping screw 1 at the shear plane 3 when the predefined torque M is applied or exceeded (cf. in particular FIG. 1c).

As illustrated in FIGS. 1b and 1d, the assembly head 20 has at the lower side thereof a conical attachment 5, wherein the conical attachment 5 is formed between the shear plane 3 and the assembly head 20. The conical attachment 5 tapers in this case in the pretensioning direction. Therefore, the conical attachment 5 faces with the greater diameter thereof the assembly head, whereas the smaller diameter of the conical attachment 5 faces the shear plane 3 at the upper side of the clamping head 10.

Furthermore, the assembly head is provided at the upper side thereof with a cross-like recess 22 for the positive-locking insertion of a tool (for example, screwdriver) when the clamping screw 1 is tightened and is in the form of a (an external) hexagon. One of the six sides is designated 24.

The clamping head 10 has a lower contact side 12 which produces a pressing contact against the clamping apparatus of the clip when the clamping screw 1 is tightened, wherein the pressing contact is introduced over a circumferential pretensioning lip 11 at the contact side 12.

When FIG. 1d, FIG. 2a and FIG. 2b are viewed together, they show that the clamping head 10 has a plate-like main body which extends between the circumferential pretensioning lip 11 and the shear plane 3 and which is configured to have a greater diameter than the assembly head 20. The circumferential pretensioning lip 11 of the clamping head 10 projects further in the pretensioning direction X than the plate-like main body of the clamping head 10. The shaft 6 has in this case a conical transition 7 to the plate-like main body of the clamping head 10. Furthermore, the clamping head 10 has at least two sides 2 for manual release.

FIG. 2a to FIG. 2c relate to an alternative embodiment, according to which the assembly head 20 is in the form of a hollow profile directly at the shear plane 3 of the clamping head 10. In this case, the shear plane 3 is intended to be understood to be virtually a separation plane, at which the assembly head 20 is separated when the clamping head 20 shears off. The recess 22 is configured in a cylindrical manner at the upper side of the assembly head 20, wherein the external geometry of the assembly head has a plurality of sides 24.

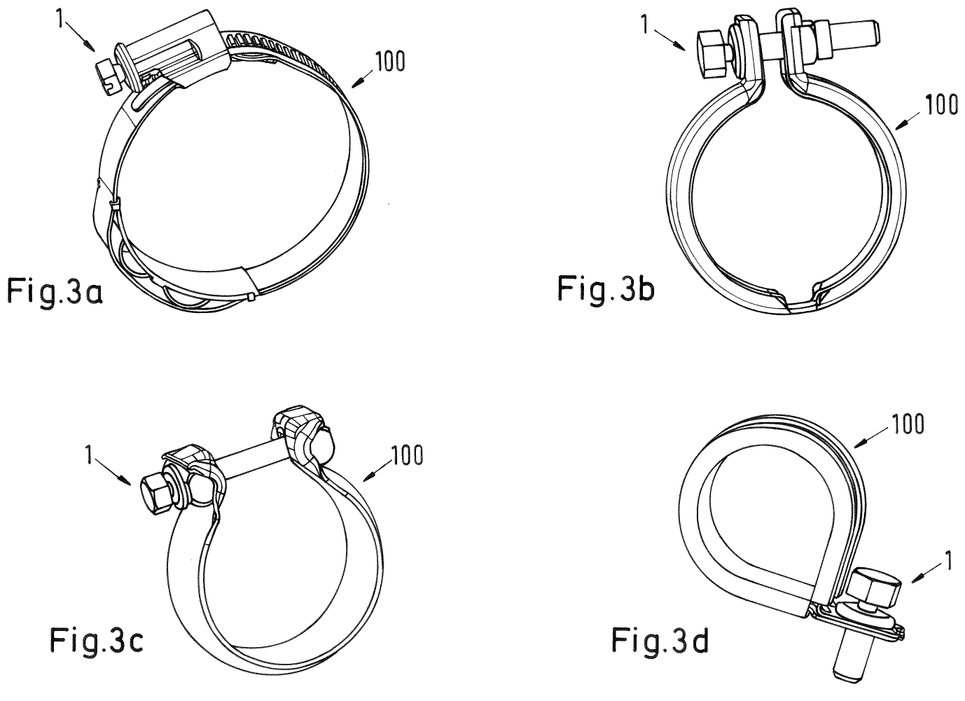

FIG. 3a to FIG. 3d illustrate different exemplary uses of the clamping screw 1 according to embodiments. In this case, different clips 100 are clamped or secured via the clamping screw 1.

In FIG. 3a, the clamping screw 1 is fitted to a clamping apparatus of a worm drive clip 100.

FIG. 3b shows a profile clip 100 which is clamped at the ends thereof via a clamping screw 1.

FIG. 3c illustrates an exhaust gas clip or spherical zone exhaust gas clip 100. The clamping screw 1 according to an embodiment is guided through openings at the ends of the exhaust gas clip 100.

FIG. 3d shows a pipe clip 100 which has two legs which are located one above the other or on each other and which are clamped via a clamping screw 1. The clamping screw 1 is guided through the legs.

The clip according to an embodiment with a clamping screw can relate generally to line clips and clamping clips, where it is necessary to ensure a predefined torque. In particular, the disclosure relates to applications in the field of automotive technology, such as, for example, hose clips with clamping heads which are connected via the clamping screw. However, the clip can also be in the form of a worm drive clip with a housing in which the clamping screw is guided. Alternatively, the clip may also be in the form of a profile clip, retention clip, pipe clip or clamping clip for connecting two pipe ends.

All the features and advantages which are derived from the claims, description and drawings, including constructive details, spatial arrangements and method steps, may be inventively significant both per se and in extremely varied combinations.

Furthermore, in general, while a multitude of embodiments have been depicted and described with a multitude of components in each embodiment, in alternative embodiments the components of various embodiments could be intermixed, combined, and/or exchanged for one another. In other words, components described in connection with a particular embodiment are not necessarily exclusive to that particular embodiment.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

K Head portion of screw
S Shaft portion of screw
X Pretensioning direction
M Predefined torque
1 Clamping screw
2 Side
3 Shear plane
5 Conical attachment
6 Shaft
7 Conical transition
10 Clamping head
11 Pretensioning lip
12 Contact side
20 Assembly head
22 Recess
24 Side
30 Thread region
100 Clip

1. A clip having a clip band which has two ends which can be connected to each other by a clamping apparatus which has a clamping screw having a head portion (K) and a shaft portion (S), wherein the shaft portion (S) has a thread region and the head portion (K) has a clamping head for applying a pretensioning force and an assembly head for tightening the clamping screw, wherein the clamping head has a shear plane at the upper side thereof, wherein the shear plane is arranged between the clamping head and the assembly head, wherein the assembly head shears off from the clamping head of the clamping screw at the shear plane if a predefined torque (M) is applied.

2. The clip as claimed in claim 1, wherein the clamping screw is configured integrally with the clamping head and the assembly head.

3. The clip as claimed in claim 1, wherein the assembly head has at the lower side thereof a conical attachment, wherein the conical attachment is formed between the shear plane and the assembly head.

4. The clip as claimed in claim 1, wherein the assembly head has at the upper side thereof a recess for the positive-locking insertion of a tool when the clamping screw is tightened, wherein the recess is cross-like.

5. The clip as claimed in claim 1, wherein the assembly head has at least two sides, wherein the assembly head is in the form of a hexagon.

6. The clip as claimed in claim 1, wherein the clamping head has a lower contact side which produces a pressing contact at the clamping apparatus of the clip when the clamping screw is tightened, wherein the pressing contact is produced over a circumferential pretensioning lip at the contact side.

7. The clip as claimed in claim 6, wherein the clamping head has a plate-like main body which extends between the circumferential pretensioning lip and the shear plane and which is configured to be greater in diameter than the assembly head, wherein the clamping head has at least two sides.

8. The clip as claimed in claim 7, wherein the circumferential pretensioning lip of the clamping head projects further in the pretensioning direction than the main body of the clamping head.

9. The clip as claimed in claim 7, wherein the shaft has a conical transition to the main body of the clamping head.

10. The clip as claimed in claim 1, wherein the clip is a hose clip for securing a hose end to a fixed connection or to a hose connector.
